(19) United States
(12) Patent Application Publication
(10) Pub. No.: US 2025/0115262 A1
(43) Pub. Date: Apr. 10, 2025

(54) ALLOCATION OF VEHICLE SYSTEM RESOURCES BASED ON GAZE OF USER

(71) Applicant: Toyota Jidosha Kabushiki Kaisha, Toyota-shi Aichi-ken (JP)

(72) Inventors: Manuel Ludwig Kuehner, Mountain View, CA (US); Aaron J. Ells, Sunnyvale, CA (US)

(21) Appl. No.: 18/482,162

(22) Filed: Oct. 6, 2023

(51) Int. Cl. B60W 50/08; B60W 30/12

(52) U.S. Cl. CPC B60W 50/085; B60W 30/12; B60W 2540/225; B60W 2555/60

(57) ABSTRACT

Systems, methods, and other embodiments described herein relate to allocating resources of a vehicle system based on a direction of a gaze of a user. In one embodiment, a method includes determining a direction of a gaze of a user using a sensor, reducing resources of a vehicle system for an action in the direction of the gaze, and increasing the resources of the vehicle system for at least one action in directions other than the direction of the gaze.

### TECHNICAL FIELD

The subject matter described herein relates, in general, to systems and methods for allocating resources of a vehicle system based on a gaze of a user.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some vehicles are equipped with one or more vehicle systems such as driver assistance systems and/or can be operated in an autonomous or semi-autonomous mode. The vehicle systems utilize a variety of resources including data computing resources and data storage resources.

### SUMMARY

This section generally summarizes the disclosure and is not a comprehensive explanation of its full scope or all its features.

In one embodiment, a method for allocating resources of a vehicle system based on a direction of a gaze of a user is disclosed. The method includes determining a direction of a gaze of a user using a sensor, reducing resources of a vehicle system for an action in the direction of the gaze, and increasing the resources of the vehicle system for at least one action in directions other than the direction of the gaze.

In another embodiment, a system for allocating resources of a vehicle system based on a direction of a gaze of a user is disclosed. The system includes a processor and a memory in communication with the processor. The memory stores machine-readable instructions that, when executed by the processor, cause the processor to determine a direction of a gaze of a user using a sensor, reduce resources of a vehicle system for an action in the direction of the gaze, and increase the resources of the vehicle system for at least one action in directions other than the direction of the gaze.

In another embodiment, a non-transitory computer-readable medium for allocating resources of a vehicle system based on a direction of a gaze of a user and including instructions that, when executed by a processor, cause the processor to perform one or more functions, is disclosed. The instructions include instructions to determine a direction of a gaze of a user using a sensor, reduce resources of a vehicle system for an action in the direction of the gaze, and increase the resources of the vehicle system for at least one action in directions other than the direction of the gaze.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating a vehicle system resources allocation system.

FIG. 2 is a more detailed block diagram of the vehicle system resources allocation system of FIG. 1.

FIG. 3 is an example of a method for allocating vehicle system resources based on at least a gaze of a user.

FIGS. 4A-4B is an example of a vehicle system resources allocation scenario.

### DETAILED DESCRIPTION

Systems, methods, and other embodiments associated with allocating resources of a vehicle system based on a gaze of a user, are disclosed. A vehicle at SAE levels—L0, L1, and L2 may require a human user to operate the vehicle. However, in addition to the human user or human operator, the vehicle can be controlled using various vehicle systems such as a sensor system, vehicle control systems, and driver assistance systems.

Vehicle system(s) may utilize large amounts of resources to function and control a vehicle. As an example, vehicle system(s) utilize sensor resources, data collection resources, computing resources, data processing resources, and data storage resources. Acquiring and maintaining large amounts of resources such as computing power and data storage results in a significant expense in terms of hardware cost, package size, cooling effort, weight, and/or energy consumption.

Current methods include allocating resources such as computing resources and data storage resources to vehicle system(s) independent of human operator participation and/or contribution. In other words, current methods include allocating resources to the vehicle system(s) to perform a function without taking into account that the human operator may be focused on performing the same function. This may lead to a redundancy in data collection, data processing, and/or data storage resources where both the human operator and the vehicle system(s) are processing the same information and performing similar functions. As such, there is an unnecessary expenditure of resources.

Accordingly, in one embodiment, the disclosed approach is a system that determines a direction of a gaze of a user using a sensor, reduces resources of a vehicle system for an action in the direction of the gaze, and increases the resources of the vehicle system for at least one action in directions other than the direction of the gaze. The gaze of the user is based on a head movement and/or an eye movement of the user.

The system may receive the direction of the gaze of the user and/or the rate at which the head and/or the eyes of the user are moving using a sensor. The system may further include receiving what event or object the user was looking at and/or for how long the user was looking at the event or object. The system may utilize the received information to determine whether the user was distracted or was focused on an event or object that is relevant to the operation of the vehicle.

The system may then determine other directions in the environment surrounding the vehicle that are relevant to the operation of the vehicle. The system may identify the other directions using one or more various methods such as machine learning techniques, formulae, and artificial intelligence methods.

The system may then reallocate or redistribute the resources utilized by the vehicle systems such that the portion of the vehicle systems processing information and performing functions in the directions other than the direction of the gaze are allocated additional resources while the portion of the vehicle systems processing information and performing functions in the direction of the gaze are allocated less resources.

The embodiments disclosed herein present various advantages over the current methods. First, the embodiments reduce vehicle operation redundancy. Second, the embodiments provide better and more contextual exploitation of resources. Third, the embodiments provide more resources to portions of the vehicle systems that may be in need of more resources to better process data and function.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

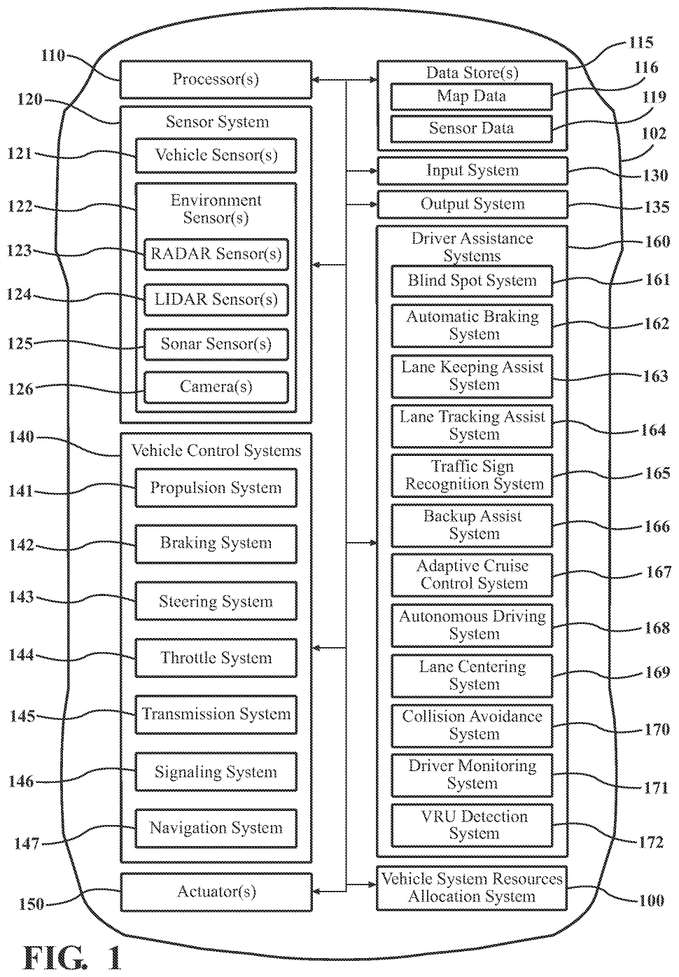

Referring to FIG. 1, a block diagram of a vehicle 102 incorporating a vehicle system resources allocation system 100 is illustrated. The vehicle 102 includes various elements. It will be understood that in various embodiments, it may not be necessary for the vehicle 102 to have all of the elements shown in FIG. 1. The vehicle 102 can have any combination of the various elements shown in FIG. 1. Further, the vehicle 102 can have additional elements to those shown in FIG. 1. In some arrangements, the vehicle 102 may be implemented without one or more of the elements shown in FIG. 1. While the various elements are shown as being located within the vehicle 102 in FIG. 1, it will be understood that one or more of these elements can be located external to the vehicle 102. Further, the elements shown may be physically separated by large distances. For example, as discussed, one or more components of the disclosed system can be implemented within a vehicle while further components of the system can be implemented within a cloud-computing environment.

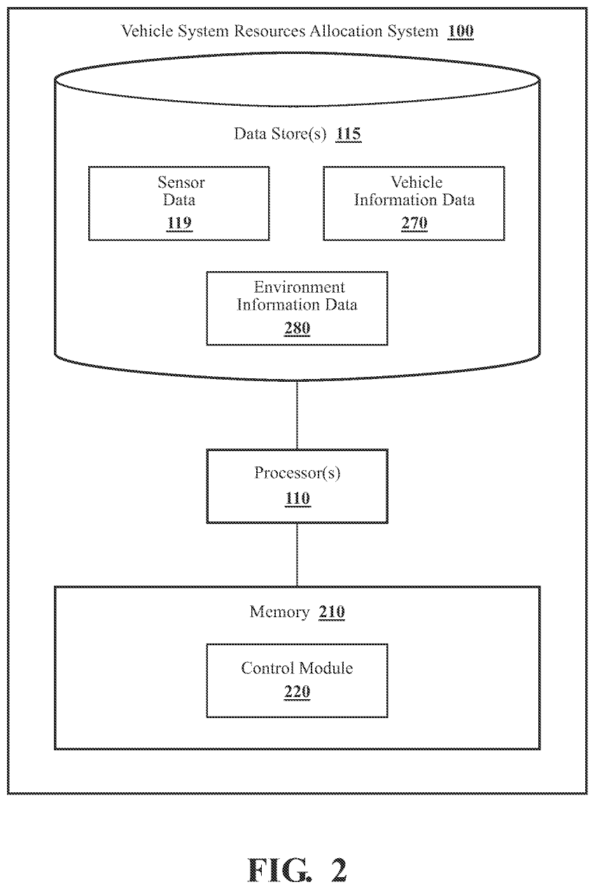

Some of the possible elements of the vehicle 102 are shown in FIG. 1 and will be described along with subsequent figures. However, a description of many of the elements in FIG. 1 will be provided after the discussion of FIGS. 2-4B for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 102 includes a vehicle system resources allocation system 100 that is implemented to perform methods and other functions as disclosed herein relating to allocating resources of a vehicle system based on a direction of a gaze of a user. As an example, the vehicle system resources allocation system 100, in various embodiments, may be implemented partially within the vehicle 102 and may further exchange communications with additional aspects of the vehicle system resources allocation system 100 that are remote from the vehicle 102 in support of the disclosed functions. Thus, while FIG. 2 generally illustrates the vehicle system resources allocation system 100 as being self-contained, in various embodiments, the vehicle system resources allocation system 100 may be implemented within multiple separate devices some of which may be remote from the vehicle 102.

The vehicle 102 can include one or more vehicle systems 120, 140, 160. The vehicle systems 140 can include one or more devices, applications, and/or combinations thereof, now known or later developed, configured to control the movement, speed, maneuvering, heading, direction, etc. of the vehicle 102. The vehicle systems 120, 140, 160 can include a sensor system 120, vehicle control systems 140, and/or driver assistance systems 160. The vehicle control systems 140 can include a propulsion system 141, a braking system 142, a steering system 143, a throttle system 144, a transmission system 145, a signaling system 146, and/or a navigation system 147.

The vehicle systems 120, 140, 160 can include a sensor system 120. The sensor system 120 can include one or more vehicle sensors 121 and/or one or more environment sensors 122. However, it will be understood that the embodiments are not limited to the particular sensors described. The vehicle sensor(s) 121 can detect, determine, and/or sense information about the vehicle 102 itself. In one or more arrangements, the vehicle sensor(s) 121 can be configured to detect, and/or sense position and orientation changes of the vehicle 102, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), and/or other suitable sensors. The vehicle sensor(s) 121 can be configured to detect, and/or sense one or more characteristics of the vehicle 102.

The environment sensor(s) 122 can detect, determine, and/or sense information about an environment surrounding the vehicle 102. The environment sensor(s) can be configured to detect, determine, and/or sense events occurring inside the vehicle 102 as well as outside the vehicle 102. As an example, in one or more arrangements, the environment sensor(s) 122 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras. Any sensor in the sensor system 120 that is suitable for detecting and observing humans, human facial expression, human head movement and direction, human eye movement and direction can be used inside the vehicle 102 to observe the users. In other words, the sensor system 120 may include a sensor such as a camera that is capable of determining a direction of a gaze of a user. In such a case, the user may be a person operating the vehicle 102 and/or a passenger in the vehicle 102. The gaze of the user may be based on a head movement of the user and/or a direction that the head of the user is facing. The head movement may include a rate at which the head is moving. Additionally and/or alternatively, the gaze of the user may be based on an eye movement of the user and/or a direction that the eye of the user is facing. The eye movement may include a rate at which the eye is moving.

The vehicle systems 120, 140, 160 can include one or more driver assistance systems 160. The driver assistance systems 160 can include any vehicle system or vehicle control system for assisting a user operating a vehicle 102 such as a blind spot system 161, an automatic braking system 162, a lane keeping assist system 163, a lane tracking assist system 164, a traffic sign recognition system 165, a backup assist system 166, an adaptive cruise control system 167, an autonomous driving system 168, a lane centering system 169, a collision avoidance system 170, a driver monitoring system 171, and/or a vulnerable road user (VRU) detection system 172. The vulnerable road users include pedestrians, cyclists, and motorcyclists.

The vehicle system(s) 120, 140, 160 may include one or more resources to be operable. As an example, the vehicle system 120, 140, 160 may include a data collection resource, a data processing resource, and/or a data storage resource. A data collection resource refers to a resource the vehicle system 120, 140, 160 utilizes to sense data, receive, transmit, exchange, and/or exchange data. A data processing resource refers to a resource the vehicle system 120, 140, 160 utilizes to process data such as computing resources. A data storage resource refers to a resource the vehicle system 120, 140, 160 utilizes to store data such as a data storage unit, a database, and/or a memory unit. The resources may be dedicated to one vehicle system 120, 140, 160 and the vehicle system 120, 140, 160 may rely on the vehicle system resources allocation system 100 for managing, allocating and/or optimizing the use of the resources. Additionally and/or alternatively, two or more vehicle systems 120, 140, 160 may share a resource and may rely on the vehicle system resources allocation system 100 for managing, allocating and/or optimizing the use of the resources.

With reference to FIG. 2, a more detailed block diagram of vehicle system resources allocation system 100 is shown. The vehicle system resources allocation system 100 may include a processor(s) 110. Accordingly, the processor(s) 110 may be a part of the vehicle system resources allocation system 100, or the vehicle system resources allocation system 100 may access the processor(s) 110 through a data bus or another communication pathway. In one or more embodiments, the processor(s) 110 is an application-specific integrated circuit that may be configured to implement functions associated with a control module 220. More generally, in one or more aspects, the processor(s) 110 is an electronic processor, such as a microprocessor that can perform various functions as described herein when loading the control module and executing encoded functions associated therewith.

The vehicle system resources allocation system 100 may include a memory 210 that stores the control module 220. The memory 210 may be a random-access memory (RAM), read-only memory (ROM), a hard disk drive, a flash memory, or other suitable memory for storing the control module 220. The control module 220 includes, for example, computer-readable instructions that, when executed by the processor(s) 110, cause the processor(s) 110 to perform the various functions disclosed herein. While, in one or more embodiments, the control module 220 is a set of instructions embodied in the memory 210, in further aspects, the control module 220 includes hardware, such as processing components (e.g., controllers), circuits, etc. for independently performing one or more of the noted functions.

The vehicle system resources allocation system 100 may include a data store(s) 115 for storing one or more types of data. Accordingly, the data store(s) 115 may be a part of the vehicle system resources allocation system 100, or the vehicle system resources allocation system 100 may access the data store(s) 115 through a data bus or another communication pathway. The data store(s) 115 is, in one embodiment, an electronically based data structure for storing information. In at least one approach, the data store 115 is a database that is stored in the memory 210 or another suitable medium, and that is configured with routines that can be executed by the processor(s) 110 for analyzing stored data, providing stored data, organizing stored data, and so on. In either case, in one embodiment, the data store 115 stores data used by the control module 220 in executing various functions. In one embodiment, the data store 115 may be able to store sensor data 119 and/or other information that is used by the control module 220.

The data store(s) 115 may include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 may be a component of the processor(s) 110, or the data store(s) 115 may be operatively connected to the processor(s) 110 for use thereby. The term “operatively connected” or “in communication with” as used throughout this description, can include direct or indirect connections, including connections without direct physical contact.

In one or more arrangements, the data store(s) 115 can include sensor data 119. The sensor data 119 can originate from the sensor system 120 of the vehicle 102. The sensor data 119 can include data from visual sensors, audio sensors, and/or any other suitable sensors in the vehicle 102 and/or the sensor system 120.

In one or more arrangements, the data store(s) 115 can include vehicle information data 270. The vehicle information data 270 may include information about the vehicle 102 such as speed of travel, which vehicle systems 120, 140, 160 are currently engaged, autonomous operation level currently being utilized, and/or energy levels (e.g., fuel levels or electric charge). The vehicle information data 270 may be from the vehicle control system(s) 140, the sensor system 120, the driver assistance systems 160, and/or any suitable control or monitoring system.

In one or more arrangements, the data store(s) 115 can include environment information data 280. The environment information data 280 may include information about the environment inside and/or surrounding the vehicle 102. As an example, the environment information data may include a direction that the user is facing. As such, the environment information data may include a direction that the head of the user is facing and/or a direction that the eye(s) of the user is facing. The environment information data may further include a rate at which the head and/or the eye of the user is moving.

The environment information data may include information about the environment surrounding the vehicle 102. The environment information data 280 may include information of objects outside the vehicle 102. The environment information data 280 may include a relationship between the direction and/or the rate of change of direction of the head and/or eyes of the user and an object outside the vehicle 102. In other words, the environment information data 280 may include information indicating that the head and/or eye movement of the user is or is not tracking an object outside the vehicle.

The environment information data 280 may include traffic levels, weather conditions, location, condition, and other characteristics of the path that the vehicle 102 is travelling on. The weather conditions may include rain levels, snow levels, visibility conditions such as fog. The location of the path(s) may include geographic coordinates of the path. The condition of the path may include information about the physical condition of the path such as surface friction, the presence of potholes, road debris, and vegetation. Other characteristics of the path may include lane markings and borders on the path.

The sensor data 119, the vehicle information data 270, and the environment information data 280 may be digital data that describe information used by the vehicle system resources allocation system 100.

In one embodiment, the control module 220 may include instructions that, when executed by the processor(s) 110, cause the processor(s) 110 to determine a direction of a gaze of a user using a sensor. As previously mentioned, the user may include a person operating a vehicle 102 and/or a person that is a passenger in the vehicle 102. The direction of the gaze of the user refers to the direction that the user is facing. As an example, the user may be facing forward, towards a path in front of the vehicle 102. As another example, the user may turn their head and/or move their eyes to the left or right of the user such that the user is facing the left or the right of the vehicle 102 respectively.

In one embodiment, the control module 220 may receive sensor data 119 that includes the direction of the gaze of the user. The sensor data 119 may be in any suitable format such as an image format or a video format.

The direction of the gaze may include the direction that the head of the user is facing and/or the direction that the eye of the user is facing. The direction of the gaze may also include a rate of change of direction of the gaze of the user. The rate of change of the gaze may include the rate at which the head of the user is moving or turning and/or the rate at which the eye(s) of the user is moving or turning. In the general, the gaze of the user is based on a head movement and/or an eye movement. As such, the sensor data 119 may include the direction and/or the rate of change of direction of the head and/or the eye(s) of the user.

The control module 220 may receive the sensor data 119 from the sensor system 120 indicating the direction of the gaze of the user. The control module 220 may compare the direction of the head and/or the eyes of the user in the sensor data 119 to the direction of the head and/or the eye(s) of the user when the user is facing forward, toward the path in front of the vehicle 102. The control module 220 may compare the direction of the head only, the direction of the eye(s) only, or the directions of both the head and the eyes to the forward-facing directions.

The control module 220 may determine whether the direction of the gaze of the user exceeds a predetermined threshold angle. The control module 220 may measure an angle difference between the direction of the gaze of the user as measured by the sensor system 120 and the direction of the gaze when the user is facing forward. The control module 220 may compare the angle difference to the predetermined threshold angle. In a case where the angle difference exceeds the predetermined threshold angle, the control module 220 may reallocate resources of one or more vehicle systems 120, 140, 160. In a case where the angle difference does not exceed the predetermined threshold angle, the control module 220 may not reallocate resources of the vehicle systems.

The control module 220 may determine a rate of change of direction of the gaze of the user. In such a case, the control module 220 may determine how fast or how slowly the user is moving or turning their head and/or their eyes. The control module 220 may determine the rate of change of direction based on a set of images and/or a video of the head and/or eyes of the user. The control module 220 may then compare the rate of change of direction with a predetermined threshold rate. The control module 220 may then determine whether the rate of change of direction exceeds the predetermined threshold rate.

The control module 220 may determine based on the rate of change of direction whether the user is focusing on a particular object or whether the head and/or eyes of the user were wandering and are expected to return to facing forward. The control module 220 may further determine whether the user is focusing on a particular object or event based on whether the control module 220 receives sensor data 119 related to the direction of the gaze of the user and the sensor data 119 includes an object or an event that is moving at a pace that is similar to the movement of the head and/or eyes of the user and/or appears to be in the line of sight of the user.

In one embodiment, the control module 220 may include instructions that, when executed by the processor(s) 110, cause the processor(s) 110 to reduce resources of a vehicle system 120, 140, 160 for an action in the direction of the gaze and increase the resources of the vehicle system 120, 140, 160 for at least one action in directions other than the direction of the gaze.

As previously mentioned, the vehicle system 120, 140, 160 is any system in the vehicle 102 used to operate the vehicle 102. The vehicle system 120, 140, 160 can include the sensor system 120, the vehicle control systems 140, and/or driver assistance systems 160. More specifically, the vehicle systems 120, 140, 160 can include the sensor system 120, a blind spot system 161, an automatic braking system 162, a lane keeping assist system 163, a lane tracking assist system 164, a traffic sign recognition system 165, a backup assist system 166, an adaptive cruise control system 167, an autonomous driving system 168, a lane centering system 169, a collision avoidance system 170, a driver monitoring system 171, and/or a vulnerable road user (VRU) detection system 172.

An action of a vehicle system 120, 140, 160 refers to the function or operation of the vehicle system 120, 140, 160. A vehicle system 120, 140, 160 may perform an action or a function that is direction specific. As an example, a sensor system 120 may monitor a left side, a front side, a right side, and/or a rear side of the vehicle 102. As another example, a lane keeping assist system 163 may monitor both the left and right sides of the vehicle 102. As another example, the traffic sign recognition system 165 may monitor traffic signs in the direction that the vehicle 102 is moving towards and traffic signs that are relevant to the vehicle 102.

The vehicle system(s) 120, 140, 160 include resources that the vehicle system(s) 120, 140, 160 utilize to perform various functions and actions. The resources, as previously mentioned, may include a data collection resource, a data processing resource, and/or a data storage resource.

In a case where the control module 220 determines that the direction of the gaze of the user is forward and the user is looking straight ahead at the path in front of the vehicle 102. The control module 220 may allocate equal and/or balanced resources to vehicle systems 120, 140, 160 that are currently engaged or activated. As an example, in a case where the traffic sign recognition system 165 is activated, the control module 220 may activate environment sensors 122 evenly on the left, front, and right of the vehicle 102 to monitor the traffic signs in the left, front, and right directions surrounding the vehicle 102. The control module 220 may configure the environment sensors 122 to capture sensor data 119 at the same rate and/or the same resolution. However, in a case where the control module 220 determines that the direction of the gaze of the user is towards the left, the control module 220 may determine the angle of the direction of the gaze and if the control module 220 determines that the angle of the direction of the gaze exceeds a predetermined angle, the control module 220 may reallocate the resources. As an example, the control module 220 may deactivate the environment sensors 122 on the left of the vehicle 102. As another example, the control module 220 may activate environment sensors 122 on the left, front, and right sides of the vehicle. However, the control module 220 may configure the left environment sensors 122 to capture sensor data at a slower rate and at a lower resolution relative to the front and right environment sensors 122 while the control module 220 may configure the front and right environment sensors 122 to capture sensor data 119 at a faster rate and at a higher resolution relative to the left environment sensors 122. In addition to the control module 220 reallocating the data collection resources, the control module 220 may also reallocate the data processing resources and data storage resources. As an example, the control module may configure the data processing resources for the traffic sign recognition system 165 and/or the sensor system 120 to process the sensor data 119 relating to the left side of the vehicle 102 at a coarser granularity and less detail and process the sensor data 119 relating to the front and the right sides of the vehicle 102 at a finer granularity and in more detail. In general and as an example, the control module 220 may operate the left environment sensor 122 less and operate the front and right environment sensors 122 more when the control module 220 determines that the head and/or eyes of the user are facing leftwards. Further, the control module 220 may assign or allocate less resources to the portion of the vehicle system 120, 140, 160 that is processing data relating to the left side of the vehicle 102 and assign or allocate more resources to the portion of the vehicle system 120, 140, 160 that is processing data relating to the right side of the vehicle 102. As an example, the control module 220 may configure the data storage resources to store less data relating to the left environment sensor 122 and store more data relating to the front and right environment sensor 122.

In one embodiment, the control module 220 may include instructions that, when executed by the processor(s) 110, cause the processor(s) 110 to reduce the resources of the vehicle system 120, 140, 160 for an action in the direction of the gaze based on the rate of change of direction and increase the resources of the vehicle system 120, 140, 160 for at least one action in directions other than the direction of the gaze based on the rate of change of direction. As previously mentioned, the control module 220 may determine the rate of change of direction of the gaze of the user using various methods including sensor data 119. The control module 220 may reallocate the resources based on whether the rate of change of direction is less than, meets, or exceeds a predetermined rate. The control module 220 may utilize any suitable machine learning techniques and/or artificial intelligence methods in addition to the vehicle information data 270 and the environment information data 280 to determine whether the user is distracted, the user is focusing on an object and/or event that is relevant to the vehicle 102, the head and/or eyes of the user are wandering and are likely to return to facing the front of the vehicle 102, and/or the user intends to make a turn or change lane based on the rate of change of direction of the gaze.

The control module 220 may configure the vehicle system 120, 140, 160 to utilize less resources in the direction of the gaze of the user and reallocate the resources to the other directions that the user is not presently looking at or focusing on based on the rate of change of direction of the gaze, whether the user is distracted, the user is focusing on an object and/or event that is relevant to the vehicle 102, the head and/or eyes of the user are wandering and are likely to return to facing the front of the vehicle 102, and/or the user intends to make a turn or change lane.

In one embodiment, the control module 220 may include instructions that, when executed by the processor(s) 110, cause the processor(s) 110 to reduce the resources of the vehicle system 120, 140, 160 for an action in the direction of the gaze based on an angle of the direction of the gaze of the user and increase the resources of the vehicle system 120, 140, 160 for at least one action in directions other than the direction of the gaze based on an angle of the direction of the gaze of the user. In such an embodiment, the control module 220 may determine the angle of the direction of the gaze and may reallocate or redistribute the resources based on the angle. As such and as an example, when the gaze of the user is 10 degrees counterclockwise to facing forwards, in other words, the user is looking slightly left, the control module 220 may redistribute the resources from fifty percent for functions on the left and fifty percent for functions on the right to forty percent for functions on the left and sixty percent for functions on the right.

As another example, when the gaze of the user is 90 degrees counterclockwise to facing forwards, in other words, the user is looking left, the control module 220 may redistribute the resources from fifty percent for functions on the left and fifty percent for functions on the right to ten percent for functions on the left and ninety percent for functions on the right. As another example, when the gaze of the user is 120 degrees counterclockwise to facing forwards, in other words, the user is looking towards the back on the left side, the control module 220 may redistribute the resources from fifty percent for functions on the left and fifty percent for functions on the right to thirty-five percent for functions on the left and sixty-five percent for functions on the right. In general, the control module 220 may determine the reallocation of the resources based on the angle that the user is facing. The control module 220 may utilize one or more various methods to determine the relationship between the reallocation of resources and the angle that the user is facing. As an example, the control module 220 may utilize a table such as a look up table, a formula, a machine learning technique, and/or an artificial intelligence method.

In one embodiment, the control module 220 may include instructions that, when executed by the processor(s) 110, cause the processor(s) 110 to reduce resources of a vehicle system 120, 140, 160 for an action in the direction of the gaze based on an event and increase the resources of the vehicle system 120, 140, 160 for at least one action in directions other than the direction of the gaze based on the event. The event may be related to a condition of the vehicle 102, a condition of the path that the vehicle 102 is travelling on, an obstacle proximate to the vehicle 102, a collision proximate to the vehicle 102, traffic levels proximate to the vehicle 102, environmental conditions such as weather, visibility conditions, and/or time of day. As such, the event may be related to the vehicle 102 and/or in an environment surrounding the vehicle 102.

In such an embodiment, the control module 220 may determine the event based on sensor data 119, vehicle information data 270, and/or environment information data 280. As an example, the control module 220 may determine that the roads are covered with snow and as such, the lane markings are not fully visible. The control module 220 may determine the reallocation of resources for the lane keeping assist system 163 and lane tracking assist system 164 based on the direction of the gaze of the user as well as the event of the lane markings not being fully visible. In other words, the control module 220 may determine the reallocation of resources of the vehicle systems 120, 140, 160 based on multiple factors including the direction of the gaze of the user, the rate of change of direction of the gaze of the user, and/or the event(s). As an example, the event may be related to a safety concern or any other situation.

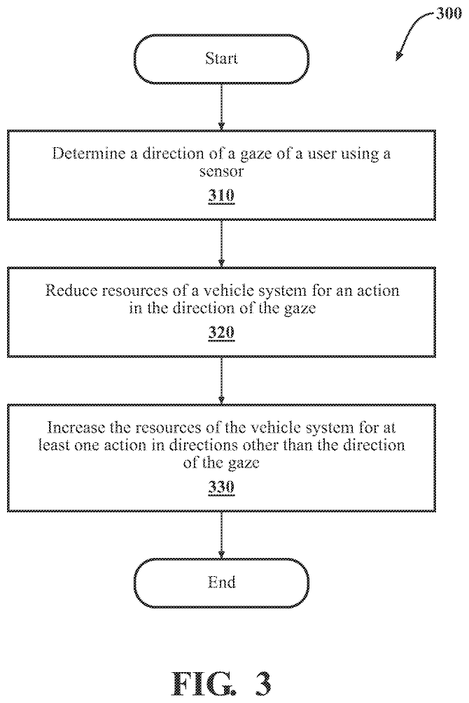

FIG. 3 is an example of a method for allocating vehicle system resources based on at least a gaze of a user. The method 300 will be described from the viewpoint of the vehicle 102 of FIG. 1 and the vehicle system resources allocation system 100 of FIG. 2. However, the method 300 may be adapted to be executed in any one of several different situations and not necessarily by the vehicle of FIG. 1 and/or the vehicle system resources allocation system 100 of FIG. 2.

At step 310, the control module 220 may cause the processor(s) 110 to determine a direction of a gaze of a user using a sensor. The control module 220 may utilize any suitable sensor such as a camera 126 to monitor and detect the direction of the gaze of the user and/or rate of change of direction of the user. As previously mentioned, the gaze of the user may be based on a head movement and/or an eye movement of the user.

At step 320, the control module 220 may cause the processor(s) 110 to reduce resources of a vehicle system 120, 140, 160 for an action in the direction of the gaze. The control module 220 may identify any vehicle systems 120, 140, 160 that are activated using any suitable method. As an example, the control module 220 may communicate, request, and receive information from the vehicle systems 120, 140, 160 indicating whether the vehicle system 120, 140, 160 is active or inactive.

The resources may be related to data collection resources, data processing resources, and/or data storage resources. The control module 220 may determine the direction of the gaze of the user and may reduce the amount of resources for monitoring, processing, and/or storing sensor data 119 and other types of data in the direction of the gaze of the user.

At step 330, the control module 220 may cause the processor(s) 110 to increase the resources of the vehicle system 120, 140, 160 for at least one action in directions other than the direction of the gaze. In addition to reducing the resources for collecting, processing, and/or storing sensor data and other types of data relating to the direction of the gaze of the user, the control module 220 may increase the resources for collecting, processing, and/or storing sensor data 119 and other types of data relating to the directions other than the direction of the daze of the user.

The control module 220 may reallocate the resources of the vehicle systems 120, 140, 160 based on multiple factors including the direction of the gaze of the user, the rate of change of direction of the gaze of the user (i.e., the rate at which the user is turning their head), and/or events relating to safety, the vehicle 102, and the environment surrounding the vehicle 102.

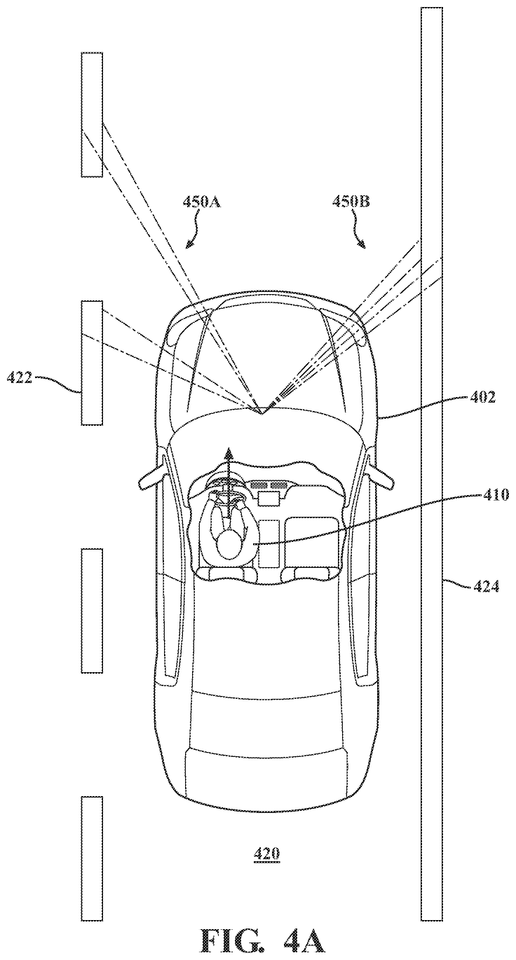

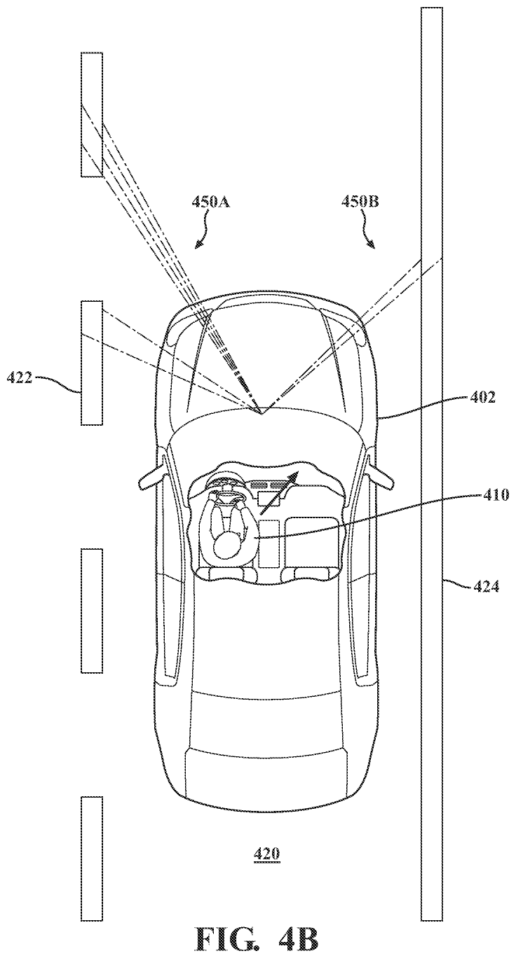

A non-limiting example of the operation of the vehicle system resources allocation system 100 will now be described in relation to FIGS. 4A-4B. FIGS. 4A-4B show an example of a vehicle system resources allocation scenario.

FIGS. 4A-4B shows a user 410 operating a vehicle 402, which is similar to the vehicle 102, on a lane 420 with left lane markings 422 and right lane markings 424. The vehicle 402 includes a vehicle system resource allocation system 100 and a lane keeping assist system 163 that is currently activated.

In FIG. 4A, the user 410 is facing forward, and the lane keeping assist system 163 is collecting sensor data 119 equally from the left and right sides of the vehicle 402. The lane keeping assist system 163 is processing sensor data 119 and other relevant data 270, 280 from the left and the right sides of the vehicle 402 evenly. In other words, the lane keeping assist system 163 is utilizing fifty percent of the data collection, data processing, and data storage resources 450A on the left side of the vehicle 402 to monitor the left lane markings 422 and fifty percent of the data collection, data processing, and data storage resources 450B on the right side of the vehicle 402 to monitor the right lane markings 424.

In FIG. 4B, the user 410 is facing the right at approximately a 45-degree angle. The control module 220 determines the direction of the gaze of the user 410 using cameras 126 inside the vehicle 402. The control module 220 redistributes, in response to the direction of the gaze being 45-degrees clockwise, the resources of the lane keeping assist system 163. The control module 220 determines a suitable distribution of resources based on a formula, machine learning techniques, and/or artificial intelligence methods. In this example, the control module 220 reduces the resources on the right side of the vehicle 402, which is the direction that the user 410 is facing and increases the resources of the lane keeping assist system 163 on the left side, which is the direction that the user is not facing. As such, the lane keeping assist system 163 is collecting sensor data 119 unequally from the left and right sides of the vehicle 402. The lane keeping assist system 163 is processing sensor data 119 and other relevant data 270, 280 from the left and the right sides of the vehicle 402 unevenly. As an example, the lane keeping assist system 163 is utilizing seventy percent of the data collection, data processing, and data storage resources on the left side of the vehicle 402 to monitor the left lane markings 422 and thirty percent of the data collection, data processing, and data storage resources on the right side of the vehicle 402 to monitor the right lane markings 424.

FIG. 1 will now be discussed in full detail as an example environment within which the system and methods disclosed herein may operate. In some instances, the vehicle 102 is configured to switch selectively between an autonomous mode, one or more semi-autonomous operational modes, and/or a manual mode. Such switching can be implemented in a suitable manner, now known, or later developed. “Manual mode” means that all of or a majority of the navigation and/or maneuvering of the vehicle is performed according to inputs received from a user (e.g., human driver). In one or more arrangements, the vehicle 102 can be a conventional vehicle that is configured to operate in only a manual mode.

In one embodiment, the vehicle 102 is configured with one or more semi-autonomous operational modes in which one or more computing systems perform a portion of the navigation and/or maneuvering of the vehicle 102 along a travel route, and a vehicle operator (i.e., driver) provides inputs to the vehicle 102 to perform a portion of the navigation and/or maneuvering of the vehicle 102 along a travel route.

The vehicle 102 can include one or more processors 110. In one or more arrangements, the processor(s) 110 can be a main processor of the vehicle 102. For instance, the processor(s) 110 can be an electronic control unit (ECU). The vehicle 102 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area.

In some instances, the map data 116 can include ground views of an area, including 260-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

The one or more data stores 115 can include sensor data 119. In this context, “sensor data” means any information about the sensors that the vehicle 102 is equipped with, including the capabilities and other information about such sensors. As will be explained below, the vehicle 102 can include the sensor system 120. The sensor data 119 can relate to one or more sensors of the sensor system 120. As an example, in one or more arrangements, the sensor data 119 can include information on one or more vehicle sensors 121 and/or environment sensors 122 of the sensor system 120.

In some instances, at least a portion of the map data 116 and/or the sensor data 119 can be located in one or more data stores 115 located onboard the vehicle 102. Alternatively, or in addition, at least a portion of the map data 116 and/or the sensor data 119 can be located in one or more data stores 115 that are located remotely from the vehicle 102.

As noted above, the vehicle 102 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 102 (including any of the elements shown in FIG. 1). The sensor system 120 can acquire data of at least a portion of the internal environment as well as the external environment of the vehicle 102 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 102 itself. In one or more arrangements, the vehicle sensor(s) 121 can be configured to detect, and/or sense position and orientation changes of the vehicle 102, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 102. In one or more arrangements, the vehicle sensor(s) 121 can include a speedometer to determine a current speed of the vehicle 102.

Alternatively, or in addition, the sensor system 120 can include one or more environment sensors 122 configured to acquire, and/or sense data inside the vehicle 102 as well as around the vehicle 102. Sensor data 119 inside the vehicle 102 can include information about one or more users in the vehicle cabin and any other objects of interest. Sensor data 119 around the vehicle 102 can include information about the external environment in which the vehicle 102 is located or one or more portions thereof.

As an example, the one or more environment sensors 122 can be configured to detect, quantify and/or sense objects in at least a portion of the internal and/or the external environment of the vehicle 102 and/or information/data about such objects.

In the internal environment of the vehicle 102, the one or more environment sensors 122 can be configured to detect, measure, quantify, and/or sense human users inside the vehicle 102 and the head and/or eye movements of the users. In the external environment, the one or more environment sensors 122 can be configured to detect, measure, quantify, and/or sense objects in the external environment of the vehicle 102, such as, for example, lane markers, signs, traffic lights, traffic signs, lane lines, crosswalks, pedestrians, curbs proximate to the vehicle 102, off-road objects, electronic roadside devices, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras. Any sensor in the sensor system 120 that is suitable for detecting and observing humans and head and/or eye movements can be used inside the vehicle 102 to observe the users. As an example, the sensor system 120 may include head motion trackers and/or eye movement sensors or trackers.

The vehicle 102 can include an input system 130. An “input system” includes any device, component, system, element or arrangement or groups thereof that enable information/data to be entered into a machine. The input system 130 can receive an input from a user (e.g., a driver or a passenger). The vehicle 102 can include an output system 135. An “output system” includes any device, component, or arrangement or groups thereof that enable information/data to be presented to a user (e.g., a person, a vehicle passenger, etc.) such as a display interface.

The vehicle 102 can include one or more vehicle systems 120, 140, 160. Various examples of the one or more vehicle systems 120, 140, 160 are shown in FIG. 1. However, the vehicle 102 can include more, fewer, or different vehicle systems 120, 140, 160. It should be appreciated that although particular vehicle systems are separately defined, each or any of the systems or portions thereof may be otherwise combined or segregated via hardware and/or software within the vehicle 102. The vehicle systems can include the sensor system 120, the vehicle control system 140, and the driver assistance systems 160. The vehicle control systems 140 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 102 and/or to determine a travel route for the vehicle 102. The navigation system 147 can include one or more mapping applications to determine a travel route for the vehicle 102. The navigation system 147 can include a global positioning system, a local positioning system or a geolocation system.

The vehicle 102 can include one or more driver assistance systems 160. The driver assistance system 160 can include one or more devices, applications, and/or combinations thereof, now known or later developed, configured to control the movement, speed, maneuvering, heading, direction, etc. of the vehicle 102. The driver assistance systems may include an autonomous driving system 168, a lane keeping assist system 163, a lane centering system 169, a collision avoidance system 170, and/or a driver monitoring system 171.

The vehicle control system(s) 140 and the driver assistance system(s) 160 can be configured to receive data from the sensor system 120 and/or any other type of system capable of capturing information relating to the vehicle 102 and/or the external environment of the vehicle 102. In one or more arrangements, the vehicle control system(s) 140 and the driver assistance system(s) 160 may use such data to generate one or more driving scene models. The vehicle control system(s) 140 and the driver assistance system(s) 160 may determine position and velocity of the vehicle 102. The vehicle control system(s) 140 and the driver assistance system(s) 160 may determine the location of obstacles, obstacles, or other environmental features including traffic signs, trees, shrubs, neighboring vehicles, pedestrians, etc.

The vehicle control system(s) 140 and the driver assistance system(s) 160 may be configured to receive, and/or determine location information for obstacles within the external environment of the vehicle 102 for use by the processor(s) 110, and/or one or more of the modules described herein to estimate position and orientation of the vehicle 102, vehicle position in global coordinates based on signals from a plurality of satellites, or any other data and/or signals that could be used to determine the current state of the vehicle 102 or determine the position of the vehicle 102 with respect to its environment for use in either creating a map or determining the position of the vehicle 102 in respect to map data.

The vehicle system(s) 120, 140, 160 either independently or in combination with the vehicle system resources allocation system 100 can be configured to determine travel path(s), current autonomous driving maneuvers for the vehicle 102, future autonomous driving maneuvers and/or modifications to current autonomous driving maneuvers based on data acquired by the sensor system 120, driving scene models, and/or data from any other suitable source such as determinations from the sensor data 119, the vehicle information data 270, and/or the environment information data 280. “Driving maneuver” means one or more actions that affect the movement of a vehicle. Examples of driving maneuvers include accelerating, decelerating, braking, turning, moving in a lateral direction of the vehicle 102, changing travel lanes, merging into a travel lane, and/or reversing, just to name a few possibilities. The vehicle system(s) 120, 140, 160 can be configured to implement determined driving maneuvers. The vehicle system(s) 120, 140, 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The vehicle system(s) 120, 140, 160 can be configured to execute various vehicle functions and/or to transmit data to, receive data from, interact with, and/or control the vehicle 102 or one or more systems thereof (e.g., one or more of vehicle system(s) 120, 140, 160).

The processor(s) 110 and/or the vehicle system resources allocation system 100 can be operatively connected to communicate with the various vehicle systems 120, 140, 160 and/or individual components thereof. For example, returning to FIG. 1, the processor(s) 110 and/or the vehicle system resources allocation system 100 can be in communication to send and/or receive information from the various vehicle systems 120, 140, 160 to control the movement, speed, maneuvering, heading, direction, etc. of the vehicle 102. The processor(s) 110 and/or the vehicle system resources allocation system 100 may control some or all of these vehicle systems 140 and, thus, may be partially or fully autonomous.

The processor(s) 110 and/or the vehicle system resources allocation system 100 can may be operable to control the navigation and/or maneuvering of the vehicle 102 by controlling one or more of the vehicle systems 120, 140, 160 and/or components thereof. As an example, when operating in an autonomous mode, the processor(s) 110, the vehicle system resources allocation system 100, and/or the vehicle systems 120, 140, 160 can control the direction and/or speed of the vehicle 102. As another example, the processor(s) 110, the vehicle system resources allocation system 100, and/or the vehicle systems 120, 140, 160 can activate, deactivate, and/or adjust the parameters (or settings) of the one or more vehicle systems 120, 140, 160 such as the driver assistance systems 160. The processor(s) 110, the vehicle system resources allocation system 100, and/or the vehicle systems 120, 140, 160 can cause the vehicle 102 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 102 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the vehicle control system(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 102 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
determining a direction of a gaze of a user using a sensor;
reducing resources of a vehicle system for an action in the direction of the gaze; and
increasing the resources of the vehicle system for at least one action in directions other than the direction of the gaze.

2. The method of claim 1, further comprising:
determining a rate of change of direction of the gaze of the user;
reducing the resources of the vehicle system for an action in the direction of the gaze based on the rate of change of direction; and
increasing the resources of the vehicle system for at least one action in directions other than the direction of the gaze based on the rate of change of direction.

3. The method of claim 1, wherein the gaze of the user is based on at least one of:
a head movement; or
an eye movement.

4. The method of claim 1, wherein the resources of the vehicle system includes at least one of:
a data collection resource;
a data processing resource; or
a data storage resource.

5. The method of claim 1, further comprising:
reducing the resources of the vehicle system for an action in the direction of the gaze based on an angle of the direction of the gaze of the user; and
increasing the resources of the vehicle system for at least one action in directions other than the direction of the gaze based on an angle of the direction of the gaze of the user.

6. The method of claim 1, wherein the vehicle system is one of:
a sensor system;
a blind spot system;
an automatic braking system;
a lane keeping assist system;
a lane tracking assist system;
a traffic sign recognition system;
a backup assist system; or
a vulnerable road user (VRU) detection system.

7. The method of claim 1, further comprising:
reducing resources of a vehicle system for an action in the direction of the gaze based on an event; and
increasing the resources of the vehicle system for at least one action in directions other than the direction of the gaze based on the event.

8. A system comprising:
a processor; and
a memory storing machine-readable instructions that, when executed by the processor, cause the processor to:
determine a direction of a gaze of a user using a sensor;
reduce resources of a vehicle system for an action in the direction of the gaze; and
increase the resources of the vehicle system for at least one action in directions other than the direction of the gaze.

9. The system of claim 8, wherein the machine-readable instructions further include instructions that when executed by the processor cause the processor to:
determine a rate of change of direction of the gaze of the user;
reduce the resources of the vehicle system for an action in the direction of the gaze based on the rate of change of direction; and
increase the resources of the vehicle system for at least one action in directions other than the direction of the gaze based on the rate of change of direction.

10. The system of claim 8, wherein the gaze of the user is based on at least one of:
a head movement; or
an eye movement.

11. The system of claim 8, wherein the resources of the vehicle system includes at least one of:
a data collection resource;
a data processing resource; or
a data storage resource.

12. The system of claim 8, wherein the machine-readable instructions further include instructions that when executed by the processor cause the processor to:
reduce the resources of the vehicle system for an action in the direction of the gaze based on an angle of the direction of the gaze of the user; and
increase the resources of the vehicle system for at least one action in directions other than the direction of the gaze based on an angle of the direction of the gaze of the user.

13. The system of claim 8, wherein the vehicle system is one of:
a sensor system;
a blind spot system;
an automatic braking system;
a lane keeping assist system;
a lane tracking assist system;
a traffic sign recognition system;
a backup assist system; or
a vulnerable road user (VRU) detection system.

14. The system of claim 8, wherein the machine-readable instructions further include instructions that when executed by the processor cause the processor to:
reduce resources of a vehicle system for an action in the direction of the gaze based on an event; and
increase the resources of the vehicle system for at least one action in directions other than the direction of the gaze based on the event.

15. A non-transitory computer-readable medium including instructions that when executed by a processor cause the processor to:
determine a direction of a gaze of a user using a sensor;
reduce resources of a vehicle system for an action in the direction of the gaze; and
increase the resources of the vehicle system for at least one action in directions other than the direction of the gaze.

16. The non-transitory computer-readable medium of claim 15, wherein the instructions further include instructions that when executed by the processor cause the processor to:
determine a rate of change of direction of the gaze of the user;
reduce the resources of the vehicle system for an action in the direction of the gaze based on the rate of change of direction; and
increase the resources of the vehicle system for at least one action in directions other than the direction of the gaze based on the rate of change of direction.

17. The non-transitory computer-readable medium of claim 15, wherein the gaze of the user is based on at least one of:
a head movement; or
an eye movement.

18. The non-transitory computer-readable medium of claim 15, wherein the resources of the vehicle system includes at least one of:
a data collection resource;
a data processing resource; or
a data storage resource.

19. The non-transitory computer-readable medium of claim 15, wherein the instructions further include instructions that when executed by the processor cause the processor to:
reduce the resources of the vehicle system for an action in the direction of the gaze based on an angle of the direction of the gaze of the user; and
increase the resources of the vehicle system for at least one action in directions other than the direction of the gaze based on an angle of the direction of the gaze of the user.

20. The non-transitory computer-readable medium of claim 15, wherein the vehicle system is one of:
a sensor system;
a blind spot system;
an automatic braking system;
a lane keeping assist system;
a lane tracking assist system;
a traffic sign recognition system;
a backup assist system; or
a vulnerable road user (VRU) detection system.
